(19) United States
(12) Patent Application Publication
(10) Pub. No.: US 2025/0315510 A1
(43) Pub. Date: Oct. 9, 2025

(54) MULTIMODAL CHATBOT SYSTEM WITH AUTHENTICATION LEVELS FOR VARIOUS INSTITUTIONS AND USERS

(71) Applicant: Wells Fargo Bank, N.A., San Francisco, CA (US)

(72) Inventors: Ramesh Yarlagadda, San Francisco, CA (US); Marc James LeBoeuf, San Francisco, CA (US); Jason Huang, San Francisco, CA (US); Karen Z. Luo, San Francisco, CA (US); Akhlaq M. Khan, San Francisco, CA (US); Chintan Mehta, San Ramon, CA (US); Amol V. Sapatnekar, San Francisco, CA (US)

(73) Assignee: Wells Fargo Bank, N.A., San Francisco, CA (US)

(21) Appl. No.: 19/172,544

(22) Filed: Apr. 7, 2025

Related U.S. Application Data
(60) Provisional application No. 63/631,354, filed on Apr. 8, 2024.

(51) Int. Cl. G06F 21/31; H04L 51/02

(52) U.S. Cl. CPC G06F 21/31; H04L 51/02

(57) ABSTRACT

Aspects of this technical solution can include receiving, by a provider computing system from an application of a client device, a query indicating a request for information; determining that a reply to the query is associated with the provider computing system or an external computing system external to the provider computing system; authenticating a user of the client device to a first authentication layer linked with the provider computing system in response to the reply and the user being associated with the provider computing system; authenticating the user of the client device to a second authentication layer linked with the external computing system in response to the reply and the user being associated with the external computing system; and causing the application to present the reply to the query according to the first authentication layer or the second authentication layer.

### CROSS-REFERENCE TO RELATED PATENT APPLICATION

This application claims the benefit of and priority to U.S. Provisional Patent Application No. 63/631,354, filed Apr. 8, 2024, which is incorporated herein by reference in its entirety and for all purposes.

### TECHNICAL FIELD

The present disclosure relates generally to a chatbot system, and more specifically to a multimodal chatbot system with authentication levels for various institutions and users.

### BACKGROUND

Chatbot systems may be designed to interact with users through natural language processing. These systems can perform a wide range of tasks, from answering questions and providing information to assisting with productivity tasks such as scheduling and reminders.

### SUMMARY

A technical solution for multimodal chatbot system with authentication levels for various institutions and users is provided. At least one aspect is directed to a provider computing system. The provider computing system includes at least one processing circuit having at least one processor coupled to at least one memory, the at least one memory storing instructions thereon that, when executed by the at least one processor, cause the at least one processing circuit to perform operations including: receiving, from an application of a client device, a query indicating a request for information; determining that a reply to the query is associated with the provider computing system or an external computing system external to the provider computing system; authenticating a user of the client device to a first authentication layer linked with the provider computing system, in response to the reply and the user being associated with the provider computing system; authenticating the user of the client device to a second authentication layer linked with the external computing system, in response to the reply and the user being associated with the external computing system; and causing the application to present the reply to the query according to the first authentication layer or the second authentication layer.

At least one aspect is directed to a method. The method can include receiving, by a provider computing system from an application of a client device, a query indicating a request for information. The method can include determining, by the provider computing system, that a reply to the query is associated with the provider computing system or an external computing system external to the provider computing system. The method can include authenticating, by the provider computing system, a user of the client device to a first authentication layer linked with the provider computing system, in response to the reply and the user being associated with the provider computing system. The method can include authenticating, by the provider computing system, the user of the client device to a second authentication layer linked with the external computing system, in response to the reply and the user being associated with the external computing system. The method can include causing, by the provider computing system, the application to present the reply to the query according to the first authentication layer or the second authentication layer.

At least one aspect is directed to a non-transitory computer readable medium including one or more instructions stored thereon that, when executed by one or more processors, cause the one or more processors to perform operations including receiving, from an application of a client device, a query indicating a request for information; determining that a reply to the query is associated with a provider computing system or an external computing system external to the provider computing system; authenticating a user of the client device to a first authentication layer linked with the provider computing system, in response to the reply and the user being associated with the provider computing system; authenticating the user of the client device to a second authentication layer linked with the external computing system, in response to the reply and the user being associated with the external computing system; causing the application to present the reply to the query according to the first authentication layer or the second authentication layer.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 is a block diagram of a computing environment, according to an example embodiment.

FIG. 2 is a diagram of a provider computing system configured to execute a multimodal chatbot system, according to an example embodiment.

FIG. 3 depicts an example mobile application presenting a unified user interface, according to an example embodiment.

FIG. 4 depicts an example mobile application presenting a travel interaction, according to an example embodiment.

FIG. 5 depicts an example mobile application presenting a travel goal interaction, according to an example embodiment.

FIG. 6 depicts an example mobile application presenting an integrations menu, according to an example embodiment.

FIG. 7 depicts an example mobile application presenting a travel interaction with a first integration, according to an example embodiment.

FIG. 8 depicts an example mobile application presenting a travel interaction with a second integration, according to an example embodiment.

FIG. 9 depicts an example mobile application presenting a small business interaction, according to an example embodiment.

FIG. 10 depicts an example mobile application presenting a market interaction, according to an example embodiment.

FIG. 11 depicts an example method of multimodal chatbot system with authentication levels for various institutions and users, according to an example embodiment.

FIG. 12 depicts an example method of multimodal chatbot system with authentication levels for various institutions and users, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Systems, methods and computer-readable media according to this disclosure can provide technical improvements and advantages at least as discussed herein. That is, this technical solution can include a client application, a backend server, or a combination thereof, to provide one or more of the technical solutions and technical improvements discussed herein. For example, this solution can include an independent application corresponding to a client application executable by a mobile device, tablet, or personal computing device. For example, the client application can be a software program stored at a mobile device or tablet, or can be a web application executable by a browser stored at the mobile device or the tablet. For example, a unified user interface can be or include a chatbot interface, in which a user can provide queries in text or multimedia format, and the client application can provide replies including text, multimedia, or partner application widgets, in response to various queries by a user. At any point during an interaction, the client application can proceed at a lower authentication level required to provide a reply, and can request credentials for a higher authentication level in response to receiving a query that may require or whose accuracy can be increased by access to personal information or financial information accessible only via authentication of the user (e.g., as a non-customer or customer, as discussed herein).

Furthermore, the systems and methods described herein provide a technical improvement to task planning. That is and as described herein, the systems, methods, and computer-readable media enable a particular technical planning solution that involves coordinating multiple agents to work in parallel, each handling specific tasks and then bringing the gathered information back to a designated agent for further processing. This designated agent can then perform a particular task based on the collected data. Additionally, there is a layer of task planning where an agent may utilize other agents to complete certain tasks. Furthermore, because not every agent requires a large language model (LLM) or access to a full amount of data to be effective, task planning as described herein may not require significant amounts of computing resources by any one agent thereby improving the technical field of computerized task planning as well as reducing usage of computing resources, which minimizes time, in enabling the complex task planning described herein.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

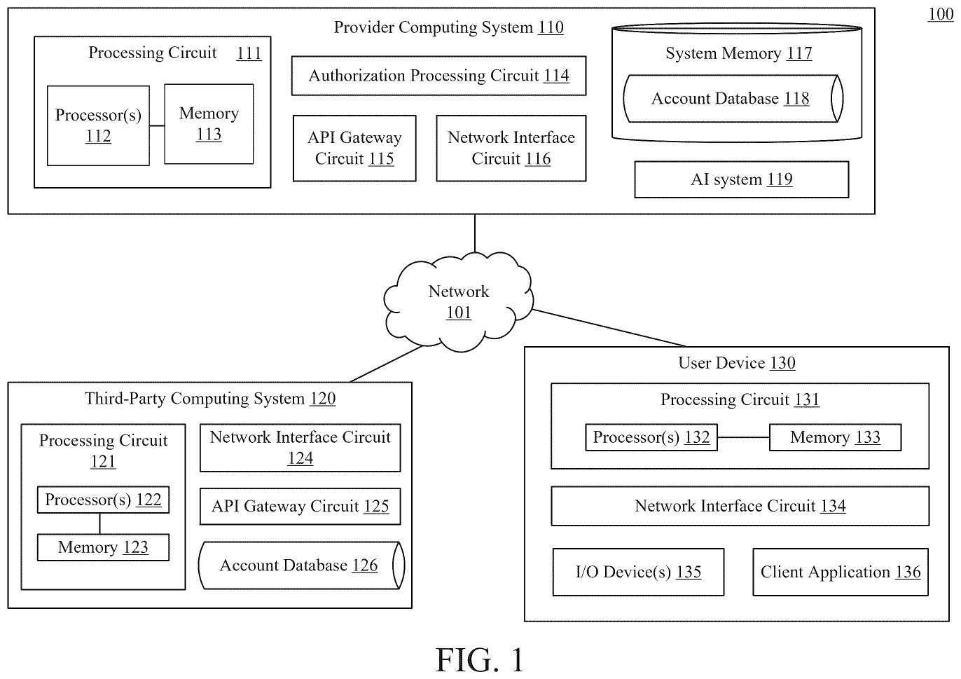

FIG. 1 is a diagram of a computing environment or system 100 for facilitating a multimodal chatbot system with authentication levels for various institutions and users, according to an example embodiment. As shown, the system 100 includes a provider institution computing system 110, at least one third-party data source/computing system 120 (shown as one third-party computing system 120, but there may be a plurality), and at least one user device 130. The provider institution computing system 110, the third-party computing system 120, and the user device 130 are in communication with each other and are connected by a network 101.

The network 101 can include any type or form of one or more wired and/or wireless networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, E.g., wired and/or wireless protocols, such as the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider institution computing system 110 is owned by, associated with, or otherwise operated by a provider institution (e.g., a bank or other financial institution) that maintains one or more accounts held by various users (e.g., a user associated with the user device 130), such as demand deposit accounts, credit card accounts, receivables accounts, and so on. In the example shown, the provider institution may be a financial institution. In other examples, the provider institution may be another institution or entity that provides various goods and/or services to users and/or customers. In some instances, the provider institution computing system 110, for example, may include one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider institution computing system 110 may include and/or have various other devices communicably coupled thereto, such as, for example, desktop or laptop computers (e.g., tablet computers), smartphones, wearable devices (e.g., smartwatches), and/or other suitable devices.

In the example shown, the provider institution computing system 110 includes at least one processing circuit 111. As also shown, the provider institution computing system 110 includes an authorization processing circuit 114, an application programming interface (API) gateway circuit 115, a network interface circuit 116, a system memory 117, and an artificial intelligence (AI) system 119. Although not specifically shown, it may be appreciated that the provider institution computing system 110 may include one or more I/O devices. The one or more I/O devices are configured to receive inputs from and display information to a user. While the term “I/O” is used, it should be understood that the I/O devices may be input-only devices, output-only devices, and/or a combination of input and output devices.

The processing circuit 111 includes one or more processors 112 coupled to one or more memory device(s). The processing circuit 111 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 111 can include at least one memory 113 operable to store or storing one or more instructions for operating components of the processing circuit 111 and operating components operably coupled to the processing circuit 111. For example, the one or more instructions can include one or more of firmware, software, hardware, operating systems, embedded operating systems. The memory 113 may include one or more devices (e.g., RAM, ROM, Flash memory, hard disk storage) for storing data and/or computer code for completing and/or facilitating the various processes described herein. The memory 113 may include non-transient volatile memory, non-volatile memory, and non-transitory computer storage media, database components, object code components, script components, or any other type of information structure for supporting the various activities and information structures described herein. The provider institution computing system 110 can include one or more communication bus controllers to effect communication between the processing circuit 111 and the other elements of the provider institution computing system 110.

The authorization processing circuit 114 is structured or configured to perform a variety of functionalities or operations to authorize users accessing the provider institution computing system 110 (e.g., accessing the provider institution computing system 110 via a client application 136 of the user device 130) and particularly, data or information stored and/or managed by the provider institution computing system 110. In some embodiments, the authorization processing circuit 114 may utilize various authentication mechanisms such as password verification, biometric scanning, token validation, multi-factor authentication, and so on that control access to the data.

The API gateway circuit 115 is structured or configured to facilitate the communication and exchange of content and data between the provider institution computing system 110, the third-party computing system 120, and the user device 130. The third-party computing system 120 and/or the user device 130 may include and/or execute API protocols that are used to establish an API session between the provider institution computing system 110 and the external devices. In this regard, the API protocols and/or sessions may allow the provider institution computing system 110 to communicate data (e.g., data regarding one or more services offered by the provider institution computing system 110) to be displayed/provided/rendered directly within the external devices. For example, the external device may activate an API protocol (e.g., via an API call), which may be communicated to the provider institution computing system 110 via the network 101 and the network interface circuit 116. The API gateway circuit 115 may receive the API call from the network interface circuit 116, and the API gateway circuit 115 may process and respond to the API call by providing API response data. The API response data may be communicated by the provider institution computing system 110 to the external device via the network interface circuit 116 and the network 101. The external device may then access (e.g., display/use/interface with) the API response data (e.g., one or more services offered by the provider institution) on the external device.

As such, the API gateway circuit 115 is structured or configured to initiate, receive, process, and/or respond to API calls (e.g., via the network interface circuit 116) over the network 101. That is, the API gateway circuit 115 may be configured to facilitate the communication and exchange of content and data between the external devices and the provider institution computing system 110. Accordingly, to process various API calls, the API gateway circuit 115 may receive, process, and respond to API calls using other circuits. Additionally, the API gateway circuit 115 may be structured to receive communications (e.g., API calls, API response data, etc.) from other circuits. That is, other circuits may communicate content and data to the provider institution computing system 110 via the API gateway circuit 115. Therefore, the API gateway circuit 115 is communicatively coupled to other circuits of the provider institution computing system 110, either tangibly via hardware, or indirectly via software.

In some instances, the network interface circuit 116 includes, for example, program logic that connects the provider institution computing system 110 to the network 101. The network interface circuit 116 facilitates secure communications between the provider institution computing system 110 and the third-party computing system 120 and the user device 130. The network interface circuit 116 also facilitates communication with other entities, such as other financial institutions, settlement systems, and so on. The network interface circuit 116 further includes user interface program logic configured to generate and present web pages to users accessing the provider institution computing system 110 over the network 101 (e.g., from the user device 130).

The network interface circuit 116 may include one or more antennas and associated communications hardware. For example, the network interface circuit 116 may include a network antenna. The network interface circuit 116 further includes any one or more of a cellular transceiver (e.g., CDMA, GSM, LTE, etc.), a wireless network transceiver (e.g., 802.11X, ZigBee, WI-FI, Internet, etc.), and/or a combination thereof (e.g., both a cellular transceiver and a wireless network transceiver).

The system memory 117 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. In this way, in some examples, the memory 113 of the processing circuit 111 may be included with the system memory 117 in some embodiments, and in other embodiments, a separate memory relative to the system memory 117. According to an exemplary embodiment, the system memory 117 is communicably coupled to the processing circuit 111 and includes computer code for executing (e.g., by the processing circuit 111 and/or the one or more processing circuits) one or more processes described herein. The system memory 117 may be or include tangible, non-transient volatile memory or non-volatile memory. The system memory 117 may also include database components, object code components, script components, or any other type of information structure for supporting the activities and information structures described in the present application.

In the example shown, the system memory 117 may further include an account database 118. In other embodiments, the account database 118 may be separate from the system memory 117. The account database 118 is structured or configured as a data or information repository that retrievably stores user account information associated with various user accounts held or otherwise maintained by the provider institution. In some instances, the user account information includes both user information and account information pertaining to a given user account. For example, in some instances, the user information may include a name, a phone number, an e-mail address, a physical address, an occupation, etc. of the user associated with the user account. In some instances, the account information may include transaction information, information pertaining to the type and corresponding capabilities of the given account, a transfer service token (e.g., a phone number, an e-mail address, or a tag associated with a particular transfer service account) associated with the user account, etc.

The AI system 119 may include one or more servers, databases, or cloud computing environments that may execute one or more AI models. The AI models may include, but are not limited to, large language models (LLMs), which can be trained to generate human-like text, speech, images, and/or components of graphical user interfaces. The AI models may be structured using a deep learning architecture that includes a multitude of interconnected layers, including attention mechanisms, self-attention layers, and transformer blocks. The AI models are trained on large datasets to assimilate patterns, structures, and relationships within the data. The trained AI models can be trained to generate outputs that resemble or closely resemble the characteristics of the input data. The AI models may be fine-tuned to generate specific output data, including data that is compatible with various database architectures or provider computing systems. The AI models can be trained via optimization of a large number of parameters, in which the AI models learn to minimize the error between its predictions and the actual data points, resulting in highly accurate and coherent generative capabilities.

In some embodiments, the system 100 may include one or more third-party computing systems 120. The third-party computing system 120 may refer to a computing system that is external to the provider institution computing system 110. In some embodiments, the system 100 may include a plurality of third-party computing systems 120 associated with a plurality of third-party entities. The third-party entity refers to another entity (e.g., another provider entity, such as another financial institution) that is a third-party relative to the provider institution. In some embodiments, the institution associated with the third-party computing system 120 may be an institution at which a user accessing the provider institution computing system 110 has an account. For example, the institution may include a credit lender, an airline provider, a retailer, a subscription service, and so on. The third-party computing system 120 may be configured to transmit data relating to the user (e.g., stored in the account database 126, as described below) to the provider institution computing system 110.

In some embodiments, the institution associated with the third-party computing system 120 may be an institution with which the provider institution is partnered. For example, the provider institution may partner with one or more credit lenders, travel services (e.g., airline providers, etc.), retailers, subscription services, and so on, such that customers of the provider institution may receive one or more benefits from the partner institution. The one or more benefits received by the customers of the provider institution may include credit services, bonus airline miles, retail discounts, reduced subscription rates, and so on.

In some embodiments, the third-party computing system 120 may be associated with a provider entity. The provider entity refers to an entity that offers one or more products and/or services to customers/users. In some embodiments, the entity may include a provider entity with which the user has an account. Alternatively or additionally, the entity may include a provider entity with which the user does not have an account. As described above, the entity may further include a provider entity with which the provider institution is partnered. The entity may include a retail provider, an airline provider, a credit lender, or any other third-party provider that is a distinct entity from the provider institution associated with the provider institution computing system 110. In some embodiments, the entity may provide user information relating to an account held at the entity and associated with the user. For example, the user information may include a points balance, a membership status, a transaction history, and so on. In some embodiments, the user information may be stored in the account database 126, as described below.

In some embodiments, the third-party computing system 120 may be associated with a third-party data source. The third-party data source may include a financial journal, an economic report, a news article, a government memorandum, and so on. The third-party data source may be configured to provide information relevant in providing a chatbot response to a user query.

As shown in FIG. 1, the third-party computing system 120 may include a processing circuit 121, a network interface circuit 124, an API gateway circuit 125, and an account database 126. The processing circuit 121 includes one or more processors 122 coupled to one or more memory device(s). The processing circuit 121 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 121 can include at least one memory 123 operable to store or storing one or more instructions for operating components of the processing circuit 121 and operating components operably coupled to the processing circuit 121. For example, the one or more instructions can include one or more of firmware, software, hardware, operating systems, embedded operating systems. The memory 123 may include one or more devices (e.g., RAM, ROM, Flash memory, hard disk storage) for storing data and/or computer code for completing and/or facilitating the various processes described herein. The memory 123 may include non-transient volatile memory, non-volatile memory, and non-transitory computer storage media, database components, object code components, script components, or any other type of information structure for supporting the various activities and information structures described herein.

The third-party computing system 120 may include the network interface circuit 124, which may be similar/identical to the network interface circuit 116 of the provider institution computing system 110, as described above. For example, the network interface circuit 124 includes program logic and various devices (e.g., transceivers, etc.) that connect the third-party computing system 120 to the network 101. In some instances, the program logic interfaces with one or more transceivers (e.g., Bluetooth, Wi-Fi, or any other suitable communication transceivers) to enable connection with the network 101. The network interface circuit 124 facilitates secure communications between the third-party computing system 120 and the provider institution computing system 110. The network interface circuit 124 also facilitates communication with other entities, such as other financial institutions, settlement systems, and so on (e.g., the provider institution computing system 110, the user device 130, etc.).

In some embodiments, the API gateway circuit 125 may include one or more APIs communicably coupled to/managed by/or otherwise associated with the third-party computing system 120. In some embodiments, the one or more APIs may be an API associated with one or more programs, services, applications, etc., offered by the third-party computing system 120 to one or more users enrolled in such corresponding one or more programs, services, applications, etc. The API gateway circuit 125 may be similar/identical to the API gateway circuit 115 of the provider institution computing system 110, as described above. For example, the third-party computing system 120 may activate the API protocol, which may be communicated to the provider institution computing system 110 via the network 101 and the network interface circuits 124/116.

The third-party computing system 120 is also shown to include an account database 126. The account database 126 is a data/information repository that is structured or configured to retrievably store user account information associated with various user accounts held or otherwise maintained by the third-party computing system 120. In some instances, the user account information includes both user information and account information pertaining to a given user account. For example, in some instances, the user information may include a name, a phone number, an e-mail address, a physical address, an occupation, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the user account, etc.

The user device 130 is owned, operated, controlled, managed, and/or otherwise associated with a user. In the example shown, the user is a customer of the provider institution. As such, the user may have one or more accounts that are stored by the account database 118 at the provider institution computing system 110. In some embodiments, the user device 130 may be or may include, for example, a desktop or laptop computer (e.g., a tablet computer), a smartphone, a wearable device (e.g., a smartwatch), a personal digital assistant, and/or any other suitable computing device. In the example shown, the user device 130 is structured as a mobile computing device, namely a smartphone.

In some embodiments, the user device 130 includes at least one processing circuit 131, a network interface circuit 134, one or more I/O devices 135, and at least one client application 136. The processing circuit 131 includes one or more processors 132 coupled to one or more memory device(s). The processing circuit 131 can include, but is not limited to, at least one microcontroller unit (MCU), microprocessor unit (MPU), central processing unit (CPU), graphics processing unit (GPU), physics processing unit (PPU), embedded controller (EC), and/or the like. The processing circuit 131 can include at least one memory 133 operable to store or storing one or more instructions for operating components of the processing circuit 131 and operating components operably coupled to the processing circuit 131. For example, the one or more instructions can include one or more of firmware, software, hardware, operating systems, embedded operating systems. The memory 133 may include one or more devices (e.g., RAM, ROM, Flash memory, hard disk storage) for storing data and/or computer code for completing and/or facilitating the various processes described herein. The memory 133 may include non-transient volatile memory, non-volatile memory, and non-transitory computer storage media, database components, object code components, script components, or any other type of information structure for supporting the various activities and information structures described herein.

In one embodiment, the user device 130 stores in the memory 133 and executes (“runs”) using the one or more processor(s) 132, the client application 136. The user device 130 may also execute a variety of other applications, such as an Internet browser application, a text messaging application (e.g., for sending MMS or SMS to the provider institution computing system 110 and/or the third-party computing system 120), and/or an application provided or authorized by entities implementing or administering certain of the operations described herein.

The network interface circuit 134 includes, for example, program logic and various devices (e.g., transceivers, etc.) that connect the user device 130 to the network 101. The network interface circuit 134 facilitates secure communications between the user device 130 and each of the provider institution computing system 110 and the third-party computing systems 120. The network interface circuit 134 also facilitates communication with other entities, such as other financial institutions, settlement systems, and so on.

Again, while the term “I/O” is used, it should be understood that the I/O devices 135 may be input-only devices, output-only devices, and/or a combination of input and output devices. In some instances, the I/O devices 135 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 135 further include one or more user interfaces (devices or components that interface with the customer), which may include one or more biometric sensors (such as a fingerprint reader, a face scanner, an iris scanner, etc.).

In the example shown, the client application 136 is a provider institution client application provided by and at least partly supported by the provider institution computing system 110 (e.g., a financial institution banking application, such as a mobile banking application). For example, in some instances, the client application 136 is coupled to the provider institution computing system 110 and may enable the user to perform various user activities (e.g., account management, account opening and/or closing actions, account withdrawals and deposits) and/or perform various transactions (e.g., the customer sending funds to a recipient, the customer receiving funds from a sender, etc.) associated with one or more user accounts of the user held at the provider institution associated with the provider institution computing system 110 (e.g., stored in the account database 126).

The client application 136 provided by the provider institution computing system 110 may additionally be coupled to the third-party computing system 120 (e.g., via one or more API(s) and/or software development kits (SDKs)) to integrate one or more features or services provided by the third-party computing system 120. Accordingly, the client application 136 is structured to provide the user with access to various services offered by the provider institution and/or the third-party provider.

In some embodiments, the client application 136 is hard coded into the memory of the user device 130. In some other embodiments, the client application 136 is a web-based interface application, where the user has to log onto or access the web-based interface before usage, and these applications are supported by a separate computing system including one or more servers, processors, network interface circuits, or the like (e.g., the provider institution computing system 110, the third-party computing system 120), that transmit the applications for use to the user device 130.

With an example structure of the system 100 being described above, example processes performable by the system 100 (or components/systems thereof) are described below. It should be appreciated that the following processes are provided as examples and are in no way meant to be limiting. Additionally, various method processes discussed herein may be performed in a different order or, in some instances, completely omitted. These variations have been contemplated and are within the scope of the present disclosure.

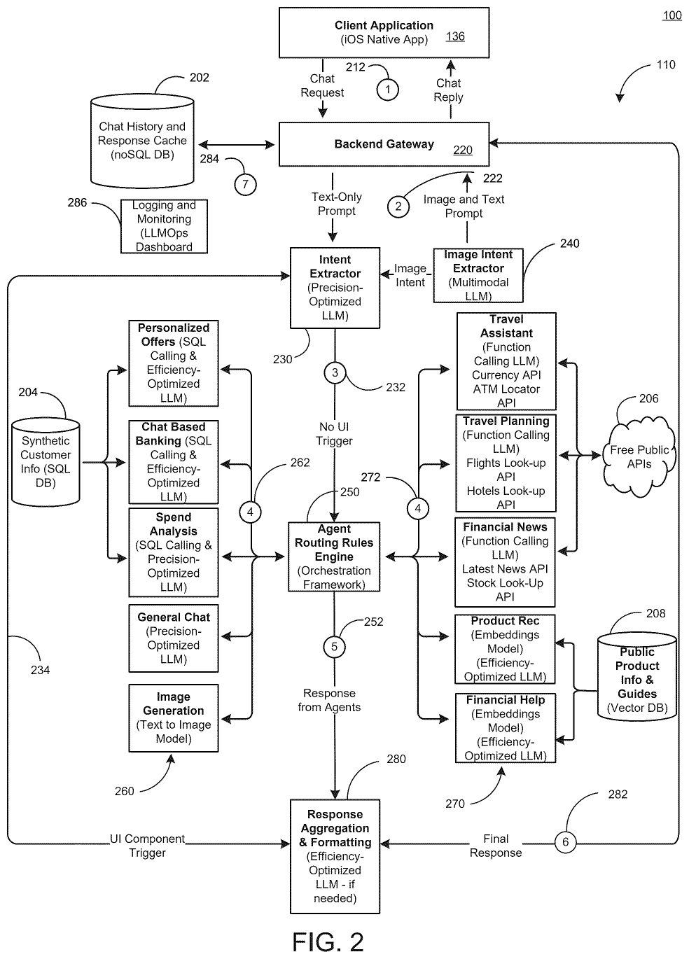

Referring to FIG. 2, a diagram of the system 100 configured to execute a multimodal chatbot system is shown. As illustrated by way of example in FIG. 2, the system 100 can include the provider institution computing system 110, public APIs 206, and the client application 136.

It should be appreciated that the various steps and processes involved in providing chatbot assistance as shown in FIG. 2 may occur sequentially and/or in parallel. In this way, the system 100 may initiate task planning in response to receiving a user query. That is, where one or more agents are used to provide a response to a user query, the one or more agents may perform their respective functionality sequentially (e.g., one after another), and/or in parallel (e.g., simultaneously with one another). For example, multiple agents may perform various steps as a swarm (e.g., working in parallel). The information generated by these multiple agents may be received by another agent (e.g., not in the swarm), and that agent may be configured to perform a next step. In this way, the agent configured to perform the next step may make a determination based on information received from the swarm of multiple agents working in parallel, and such determination may differ from a determination that may be made when receiving information from the swarm of agents sequentially (e.g., without the information from all relevant agents).

As described above, the provider institution computing system 110 is owned by, associated with, or otherwise operated by the provider institution (e.g., a bank or other financial institution, but is not limited thereto). The provider institution may have a system, employee (e.g., a hiring director, HR lead, recruiter, etc.), individual, or department that maintains one or more devices operable to obtain and analyze business information related to a given entity or organization unit within the entity (e.g., a team member of a wealth management department for a given customer class). For example, the team member may be the client associated with the client application 136, such as computer accessing a business organization network, a laptop accessing a user portal site, and so on.

The provider institution computing system 110 can include a chat history and response cache 202, a synthetic customer information memory 204, a public product information and guides memory 208, a backend gateway 220, an intent extractor circuit 230, an image intent extractor circuit 240, an agent routing rules circuit 250, first AI circuits 260 including a personalized offer circuit, a chat-based banking circuit, a spend analysis circuit, a general chat circuit, and an image generation circuit, second AI circuits 270 including a travel assistant circuit, travel planning circuit, a financial news circuit, a product recommendation circuit, and a financial help circuit, a response aggregation and formatting circuit 280, and a logging and monitoring circuit 286. For example, the synthetic customer information memory 204 can provide data for a preview mode or demonstration experience. The synthetic customer information memory 204 can cause the client application 136 to present the preview or demonstration either directly in the client application 136 for an end user, or as a guided experience through a given user experience or workflow, but is not limited thereto.

The client application 136 as discussed herein and the provider institution computing system 110 as discussed herein can provide a technical solution to support a plurality of unauthenticated and authenticated users on a unified user interface of the client application 136, with varying feature sets that can be activated or executed via the unified user interface according to given authentication levels of given individual users. For example, the client application 136 and the provider institution computing system 110 can support an unauthenticated level, an authenticated level for a non-customer, and an authenticated level for a banking customer. For example, an unauthenticated level can correspond to a user that has not logged into any authentication system. The client application 136 or the provider institution computing system 110 can still provide services and features to the unauthenticated user that do not require authentication, within the unified user interface. For example, an authenticated level for a non-customer can correspond to a user that has logged into an authentication system that has verified the identity of the user. The client application 136 or the provider institution computing system 110 can then provide services and features to the authenticated user that can leverage identity information of the user, within the unified user interface. For example, an authenticated level for a banking customer can correspond to a user that has logged into an authentication system for the provider institution that has verified the identity of the user and has granted access to personal information of the user (e.g., financial data of the user at the provider institution). The client application 136 or the provider institution computing system 110 can then provide services and features to the authenticated user that can leverage identity information of the user and the personal information of the user at the provider institution, within the unified user interface.

In an aspect, authentication layers and levels as discussed herein can correspond to users of the system. In an aspect, the provider institution computing system 110 can manage authentication, permissions and labeling of data involved with more classifications (e.g., not only a higher number and type of authentication layers and levels, but also involving additional security policies). The classification can control operation of various components of the provider institution computing system 110, and thus control actions a circuit of the provider institution computing system 110 can take. For example, a classification can instruct the provider institution computing system 110 to only use a given instance or type of LLM in response to identifying that data of a given type or restriction level is involved. For example, a classification can instruct the provider institution computing system 110 to trigger additional circuits in accordance with a given process or output (ex. PII classification, or sanitization and prompt review before sending a prompt to an external system).

In an aspect, the provider institution computing system 110 and the client application 136 can provide a first level of functionality for unauthenticated users of the unified interface. The first level of functionality can correspond to a first authentication layer that applies to unauthenticated users of the unified user interface. For example, a first level of functionality can include chatbot support for replies to queries regarding access to financial education content, ATM locator services, currency converter applications, market trends and stock overview content, and basic budgeting tools.

In an aspect, the provider institution computing system 110 and the client application 136 can provide a second level of functionality for authenticated non-customer users of the unified interface. The second level of functionality can include support for all or a portion of the first level of functionality. The second level of functionality can correspond to a second authentication layer that applies to authenticated non-customer users of the unified user interface. As discussed herein, a non-customer can correspond to a user of the client application 136 of the provider institution that does not have an account with or is not registered with the provider institution. As discussed herein, an authenticated non-customer can correspond to a user of the client application 136 of the provider institution that does not have an account with or is not registered with the provider institution, but has an account with or is registered with a third-party financial institution. For example, a second level of functionality can include chatbot support for replies to queries regarding access to credit score monitoring services, expense tracking across external accounts, financial health assessment tools, investment simulators/gamified learning and savings goals tracking.

In an aspect, the provider institution computing system 110 and the client application 136 can provide a third level of functionality for authenticated customer users of the unified interface. The third level of functionality can include support for all or a portion of the second level of functionality and the first level of functionality. The third level of functionality can correspond to a third authentication layer that applies to authenticated customer users of the unified user interface. As discussed herein, a customer can correspond to a user of the client application 136 of the provider institution that does have an account with or is registered with the provider institution, and thus is authenticated to the provider institution computing system 110. As discussed herein, the customer can also have an account with or be registered with a third-party financial institution. For example, a third level of functionality can include chatbot support for replies to queries regarding access to comprehensive account management for accounts at the provider institution, advanced budgeting tools based on financial data of the customer at the provider institution, personalized financial advice, loan management tools, integrated investment services with the provider institution, generative AI card customization at least as discussed herein, customizable bill and transaction alerts based on financial data of the customer at the provider institution, and peer-to-peer payments between accounts of the provider institution and external institutions, payment processors or entities other than the provider institution generally.

In an aspect, the client application 136 and the provider institution computing system 110 can integrate with a third-party financial institution. For example, the unified user interface at the client application 136 can provide banking as a service hub by integrating services from the provider institution and one or more third-party financial institutions. For example, an authenticated level for a banking customer of a third-party financial institution can correspond to a user that has logged into an authentication system for the third-party financial institution that has verified the identity of the user and has granted access to personal information of the user (e.g., financial data of the user at the third-party financial institution). The client application 136 or the provider institution computing system 110 can then provide services and features to the authenticated user that can leverage identity information of the user and the personal information of the user at the third-party financial institution, within the unified user interface.

In an aspect, the client application 136 can present content having multiple formats in a unified interface according to a chatbot interface. For example, the client application 136 can support multiple capabilities via a plug-in catalog associated with one or more third-party applications (e.g., via APIs). For example, a financial news circuit can obtain real-time financial data (e.g., market news, stocks, etc.) that the client application 136 can present via the unified user interface. For example, an intent extractor and an image intent extractor can support input multimodality via the client application 136 via the unified user interface. For example, input multimodality can correspond to supporting input in a variety of formats by a chatbot interface, including text queries, image data, video data, audio data, structured content from external applications (e.g., social media posts or interest board content) or any combination thereof, but is not limited thereto. The provider institution computing system 110 is not limited to queries having one or more of text and image content as discussed herein. For example, the provider institution computing system 110 can process queries including files/images/videos without a text query. For example, where a user input includes only a picture of a travel brochure, the system can infer that the query is related to travel and responsively trigger appropriate circuits directed to a travel domain. For example, the client application 136 can present customizable widgets and alerts via the unified user interface, which can be responsive to various queries or input at the unified user interface from the user or an external application or API linked with the client application 136.

Though text and image input are described variously by way of example, this technical solution is not limited to the data types or permutations of data types discussed herein. For example, when files or multimedia content is sent, all input (e.g., text and images) can be parsed or processed to determine the intent. For example, when files or multimedia content is sent, the provider institution computing system 110 can iteratively parse information as needed until the intent determination confidence satisfies a predetermined confidence threshold. For example, a user can upload a business plan PDF. In response, the intent extractor could begin by parsing a file name, file metadata and a first predetermined number of pages of the PDF before routing to an appropriate circuit that can provide a list of suggested next steps.

For example, a financial help circuit can provide intelligent savings and budget tracking that the client application 136 can present via the unified user interface. In an aspect, the intelligent savings and budget tracking can be provided by the financial help circuit at various levels of individualization or detail, based on an authentication level as discussed herein. For example, the provider institution computing system 110 can provide built-in transaction capabilities that the client application 136 can present via the unified user interface. For example, built-in transaction capabilities can include transactions with accounts of the provider institution, third-party financial institutions, payment processors, financial planning or advisory entities, or any combination thereof, but are not limited thereto. In an aspect, the built-in transaction capabilities can be provided by the backend gateway 220 at various levels of individualization or detail, based on an authentication level as discussed herein. For example, the backend gateway 220 can obtain personalized educational resources that the client application 136 can present via the unified user interface. In an aspect, personalized educational resources can be selected by the financial help circuit at various levels of individualization or detail, based on an authentication level as discussed herein.

The backend gateway 220 may be a controller structured or configured to link the provider institution computing system 110 with at least the client application 136, by one or more communication interfaces. As such, the backend gateway may include the API gateway circuits 115/125 and/or the network interface circuits 116/124/134, as describe above with reference to FIG. 1. A communication interface can include, for example, an API compatible with a particular component of the provider institution computing system 110, the client application 136, or the third-party computing system 120 as discussed herein. The communication interface can provide a particular communication protocol compatible with a particular component of the provider institution computing system 110 and a particular component of the client application 136. The backend gateway 220 can include a prompt instruction 222 (text only or text and image), and cache and logging instructions 284. The intent extractor circuit 230 can include a precision-optimized LLM. The intent extractor circuit 230 can include a no user interface trigger instruction 232, and an UI component-triggered instruction 234. The image intent extractor circuit 240 can include a multimodal LLM. The agent routing rules circuit 250 can include an orchestration framework. The agent routing rules circuit 250 can include response instructions from agents 252.

In some embodiments, the agent routing rules circuit 250 is configured to perform task planning in response to a user query. That is, the agent routing rules circuit 250 may determine whether multiple agents perform their respective functions sequentially, in parallel, or using a combination of the two. In this way, the agent routing rules circuit 250 may be configured to facilitate individual agent functionality and collective agent functionality.

The first AI circuits 260 can include a personalized offer circuit, a chat-based banking circuit, a spend analysis circuit, a general chat circuit, and an image generation circuit. The personalized offer circuit can include a SQL calling and efficiency-optimized LLM, a chat-based banking circuit SQL calling and efficiency-optimized LLM. The spend analysis circuit can include a SQL calling and precision-optimized LLM. The general chat circuit can include a precision-optimized LLM. The image generation circuit can include a text-to-image model. The first AI circuits 260 can include a first agent communication bus 262.

The second AI circuits 270 can include a travel assistant circuit, a travel planning circuit, a financial news circuit, a product recommendation circuit, and a financial help circuit. The travel assistant circuit can include a function-calling LLM, a currency API, and an ATM locator API. The travel planning circuit can include a function-calling LLM, a flights lookup API, and a hotels lookup API. The financial news circuit can include a function-calling LLM, a latest news API, and a stock lookup API. The product recommendation circuit can include an embeddings model, and an efficiency-optimized LLM. The financial help circuit can include an embeddings model, and an efficiency-optimized LLM. The second AI circuits 270 can include a second agent communication bus 272. The response aggregation and formatting circuit 280 can include an efficiency-optimized LLM. The response aggregation and formatting circuit 280 can include final response instructions 282. In some embodiments, the response aggregation and formatting circuit 280 includes instructions based on predetermined guardrails (e.g., determined by the provider institution). That is, the guardrails may be used to determine whether the final response and intermediate responses generated by various agents are valid and responsive to the user query. For example, the guardrails may include profanity filters, content validation, input validation, topic restrictions, and so on.

The client application 136 can include a chat request and chat reply instruction 212. The client application 136 may include a query input, refinement, selection, and execution interface that enables various LLMs to identify and execute input prompts that have been validated for use with the LLM by the provider institution computing system 110. For example, the client application 136 can be executed by the user device 130, as discussed herein. For example, the user device 130 may be a mobile device such as a smartphone or tablet, but is not limited thereto.

This technical solution is not limited to the examples illustrated above. For example, the customer data distribution and retrieval can be performed with respect to many different types of systems other than the databases and systems illustrated herein. For example, selection or integration of systems and types of data to be retrieved, can be determined by system according to intent classification. For example, selection or integration of systems and types of data to be retrieved, can be determined by circuit logic corresponding to authentication layers or levels as discussed herein. For example, the system can be configured or modify a configuration of one or more circuits as discuss herein, based on sensitivity (e.g., confidentiality) of the data retrieved. For example, a specific combination of sensitive data could stipulate a circuit to only utilize a self-managed model.

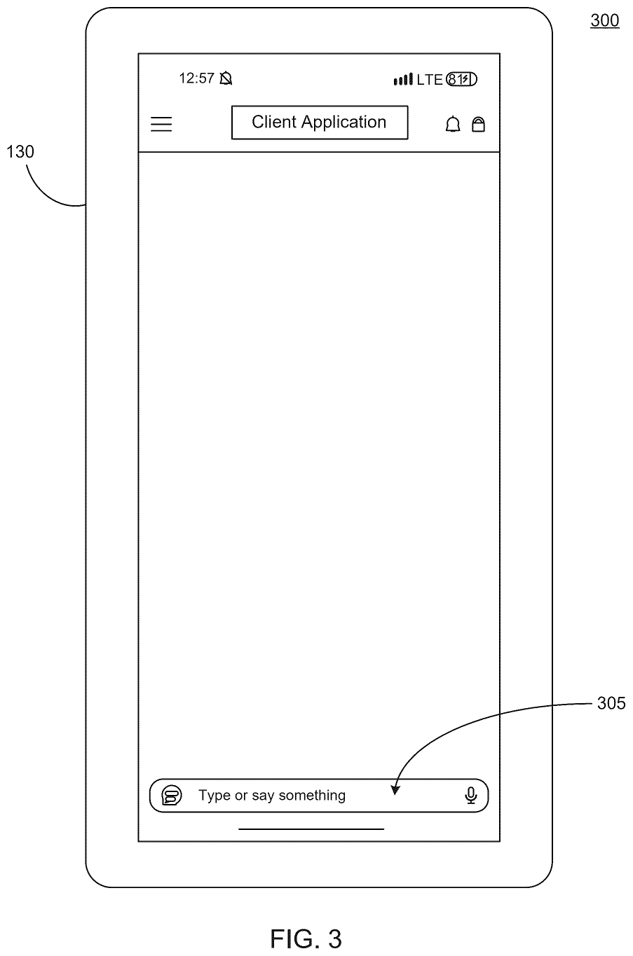

Referring to FIG. 3, a graphical user interface (GUI) 300 is shown, according to an example embodiment. The GUI 300 may be generated by the provider institution computing system 110 for display on the user device 130. In other embodiments, the GUI 300 is generated by the client application 136. In some embodiments, the GUI 300 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, FIG. 3 depicts the client application 136 presenting a unified user interface via the user device 130. As shown, the unified user interface may include an input field 305. A user of the user device 130 may submit a query (e.g., the query received at step 1110 of method 1100) via the input field 305. In some embodiments, the query submitted via the input field 305 may include text, image, or video data.

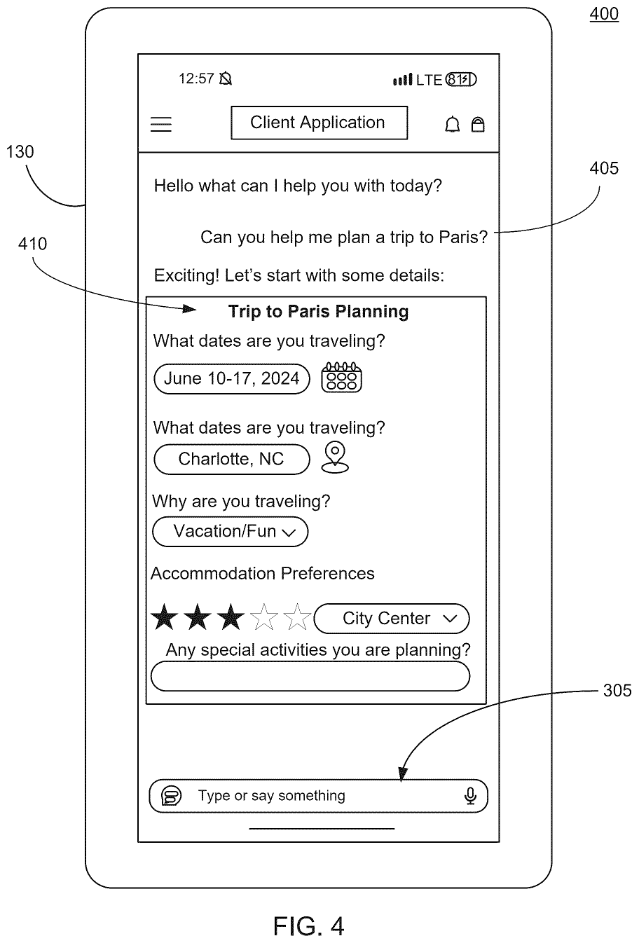

Referring to FIG. 4, a GUI 400 is shown, according to an example embodiment. The GUI 400 may be generated by the provider institution computing system 110 for display on the user device 130. In other embodiments, the GUI 400 is generated by the client application 136. In some embodiments, the GUI 400 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 400 depicts a travel interaction between a user of the user device 130 and the client application 136. Furthermore, the GUI 400 depicts the input field 305, a query 405, and a response 410. As shown, the query 405 submitted via the input field 305 may include “Can you help me plan a trip to Paris?” In turn, the response 410 to the query 405 may include a request for details regarding the user's anticipated trip to Paris such as dates of travel, departure location, reason for travel, accommodation preferences, planned activities, etc.

In some embodiments, the provider institution computing system 110 can include a deterministic API. For example, the provider institution computing system 110 can extract context based on time series historical data associated with the authenticated user, the subject matter of a query by the user, or any combination thereof. For example, in response to a user submitting the query 405 as shown in FIG. 4 (e.g., “Can you help me plan a trip to Paris?”), the provider institution computing system 110 may obtain transaction data from one or more accounts of the authenticated user for a period extending from 30 days prior to current day of request, and determine that the user has purchased luggage and travel toothpaste. In response, the provider institution computing system 110 can also obtain transaction data from one or more accounts of the authenticated user for a period from 5 days prior to current day of request, and determine that the user has purchased travel insurance. Thus, the provider institution computing system 110 can generate a reply based on time series historical data and a travel prompt (e.g., query from a user directed to a travel topic). For example, with the historical data, the provider institution computing system 110 can generate a reply object with a travel plan for specific dates. For example, without the historical data, the provider institution computing system 110 can generate a reply object with a travel plan for flexible dates or date ranges.

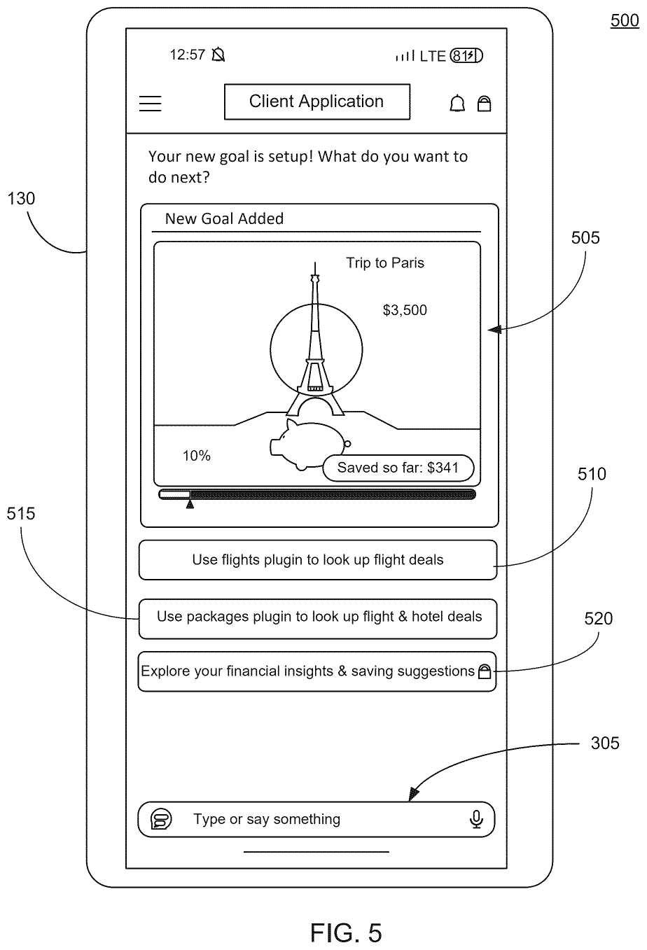

Referring to FIG. 5, a GUI 500 is shown, according to an example embodiment. The GUI 500 may be generated by the provider institution computing system 110 for display on the user device 130. In other embodiments, the GUI 500 is generated by the client application 136. In some embodiments, the GUI 500 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

As shown, the GUI 500 depicts a travel goal interaction. The travel goal interaction may include presenting a savings fund 505 relating to the travel goal. In some embodiments, the savings fund 505 as shown in FIG. 5 may be associated with the provider institution computing system 110 or the third-party computing system 120. Furthermore, the GUI 500 may display an option 510 to access a flights plugin for looking up flight deals, an option 510 to access a travel packages plugin for looking up flight and hotel deals, and an option 520 to access financial insights and saving suggestions relating to the savings fund 505. As shown in FIG. 5, the option 520 may be depicted with a lock icon. The lock icon may be used to indicate that a functionality requires an additional layer of authentication beyond a current level of authentication of the user to access the corresponding functionality (e.g., the financial insights and saving suggestions).

In some embodiments, the image generation circuit may provide generative AI-powered customization (goal images, card designing, etc.) that the client application 136 can present via the unified user interface. For example, the unified user interface can receive a text input from the user via the input field 305 to create a financial goal toward a vacation in Paris, France. The client application 136 can provide the text input from the user to the provider institution computing system 110, and the image generation circuit can generate image content or video content associated with the financial goal based on the text input. For example, the image generation circuit can generate the image of the Eiffel Tower on a sunny day, as shown in FIG. 5, and link that image with the financial goal toward the vacation in Paris, France. The client application 136 can present a card or a profile page for the financial goal toward the vacation in Paris, France, which includes the generated image content. For example, the image generation circuit can generate the image content or the video content for the financial goal by a generative AI model having a text-to-image engine (e.g., the image generation circuit).

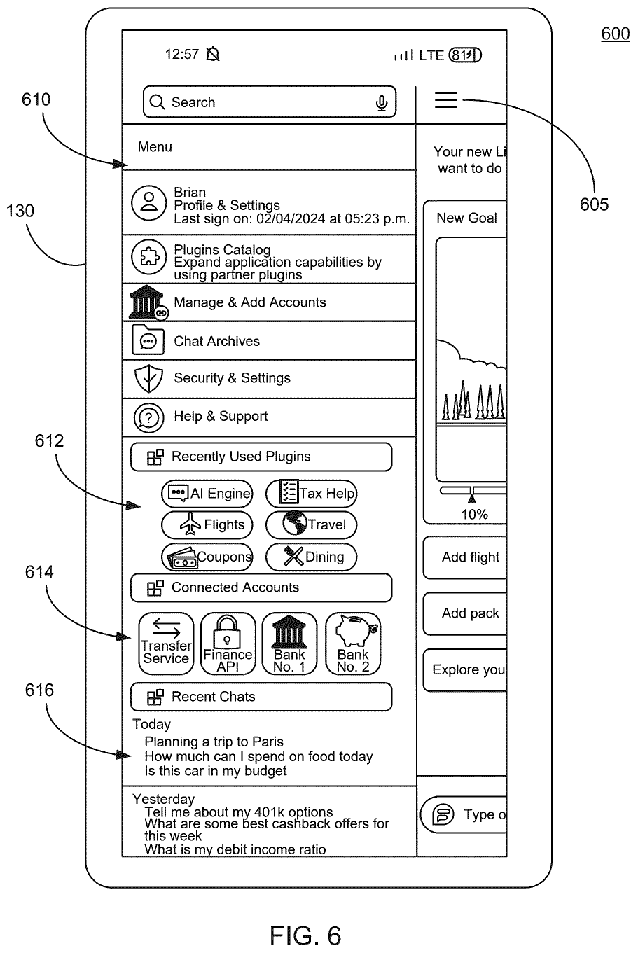

Referring to FIG. 6, a GUI 600 is shown, according to an example embodiment. The GUI 600 may be generated by the provider institution computing system 110 for display on the user device 130. In other embodiments, the GUI 600 is generated by the client application 136. In some embodiments, the GUI 600 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 600 depicts a selectable element 605 configured to present a menu 610 associated with the client application 136. The menu 610 may refer to an integrations menu including plugin options 612 that are available to the user of the user device 130 accessing the client application 136. For example, and as shown in FIG. 6, the plugin options 612 available to the user may relate to an Al engine, tax help, flights, travel, coupons, dining, and so on. The plugin options 612 may include services offered by the provider institution or a third-party institution. Furthermore, the menu 610 may include connected accounts 614 of the user accessing the client application 136. For example, and as shown in FIG. 6, the connected accounts 614 may include a transfer service account, a financial API account, an account at a first bank, an account at a second bank, and so on. The connected accounts 614 may be accounts of the user held at the provider institution or a third-party institution. The menu 610 may also depict a chat history 616. More specifically, the chat history 616 may include a summary of topics relating to chats that the user had previously on the same day as when the client application 136 is being accessed, the day before, etc. As shown in FIG. 6, the topics may include “Planning a trip to Paris,” “How much can I spend on food today,” “Is this car in my budget,” “Tell me about my 401k options,” “What are some best cashback offers for this week,” “What is my debit income ration,” etc.

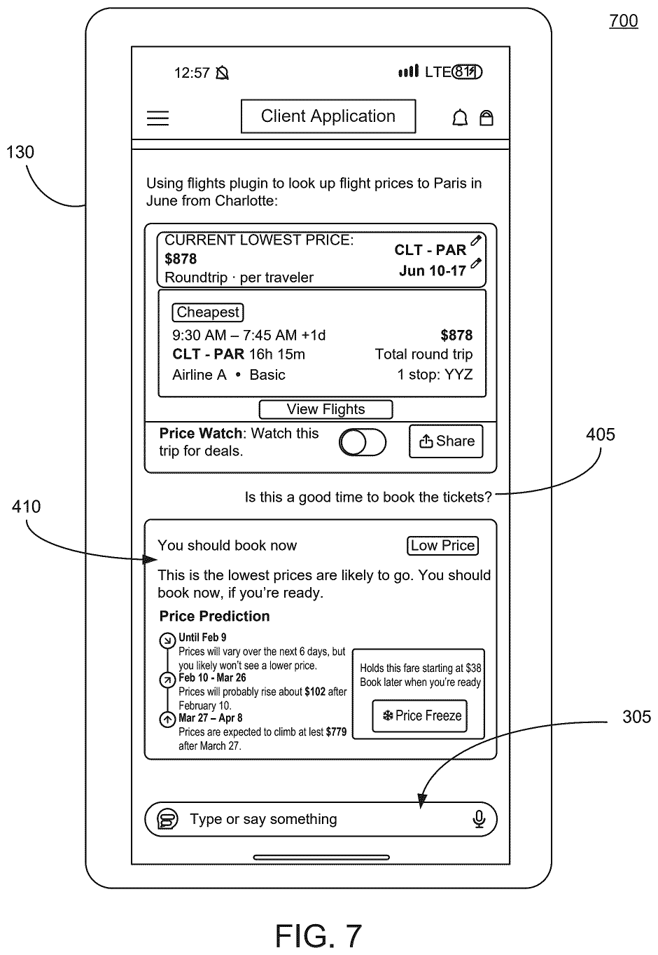

Referring to FIG. 7, a GUI 700 is shown, according to an example embodiment. The GUI 700 may be generated by the provider institution computing system 110 for display on the user device 130. In other embodiments, the GUI 700 is generated by the client application 136. In some embodiments, the GUI 700 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 700 depicts a travel interaction between a user of the user device 130 and the client application 136 using a first integration. For instance, the first integration may be a flights-related plugin from the plugin options 612, as shown in FIG. 6. In some instances, the flights-related plugin may be associated with the third-party computing system 120. In the example shown in FIG. 7, the user may use the flights plugin to research flights for an upcoming trip. In response to receiving flight information, the user may submit a query 405 via the input field 305. For example, the user may ask “Is this a good time to book the tickets?” In response to the query 405, the client application 136 may present a response 410 to the query 405 using information from the flights plugin (e.g., the third-party computing system 120. For example, in response to the query 405 shown in FIG. 7, the response 410 may include a prediction regarding whether the flight prices will change over time.

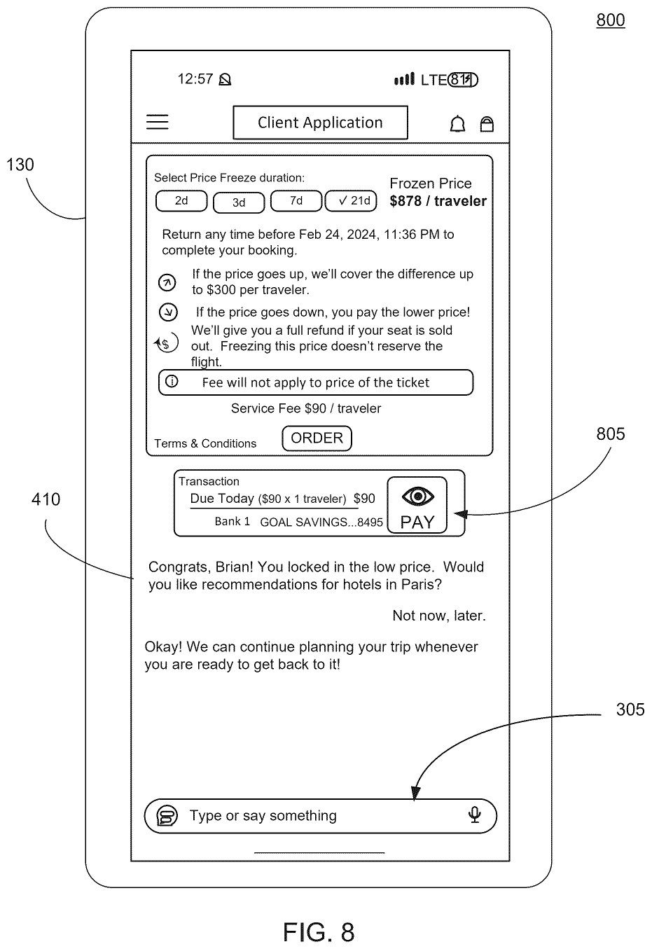

Referring to FIG. 8, a GUI 800 is shown, according to an example embodiment. The GUI 800 may be generated by the provider institution computing system 110 for display on the user device 130. In other embodiments, the GUI 800 is generated by the client application 136. In some embodiments, the GUI 800 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 800 depicts a continuation of the travel interaction between the user of the user device 130 and the client application 136 shown in FIG. 7. For instance, the GUI 800 may be presented in response to the user interacting with the “Price Freeze” option shown in FIG. 7. That is, after the user selects the “Price Freeze” option, the client application 136 may generate the GUI 800 for completing the transaction for freezing the price of the flights shown in FIG. 7. As such, the GUI 800 may present an option 805 for completing the transaction using facial recognition. Then, in response to the user completing the transaction, the client application 136 may present a response 410. As shown in FIG. 8, the response 410 may ask whether the user would like to receive hotel recommendations for the trip to Paris. The user may react to the response 410 via the input field 305.

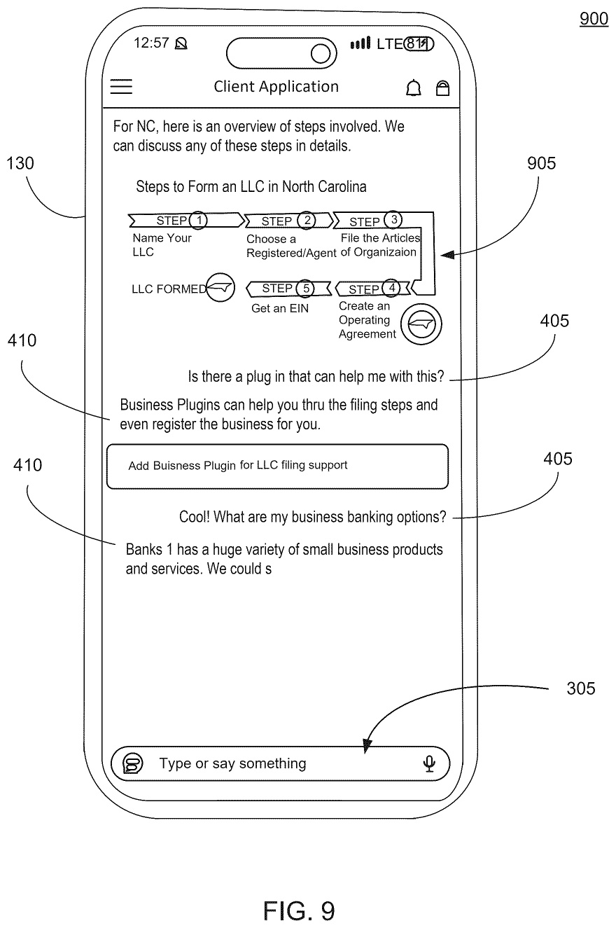

Referring to FIG. 9, a GUI 900 is shown, according to an example embodiment. The GUI 900 may be generated by the provider institution computing system 110 for display on the user device 130. In other embodiments, the GUI 900 is generated by the client application 136. In some embodiments, the GUI 900 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 900 depicts an interaction between the user of the user device 130 and the client application 136 regarding a small business. That is, the client application 136 presents information 905 regarding starting an LLC. In some embodiments, such information 905 may be retrieved from the third-party computing system 120. As shown in FIG. 9, the user may respond to the information 905 by submitting a query 405 via the input field 305. For example, in response to the information 905, the user may ask “Is there a plugin that can help me with this?” Based on the query 405, the client application 136 may present a response 410. In the example shown in FIG. 9, the response 410 may include presenting an option to integration a business plugin within the client application 136 to assist with LLC filing support. The user may submit another query 405. For instance, the user may ask “What are my business banking options?” The response 410 to this query 405 may include a suggestion of a bank at which the user can set up an account for a small business.

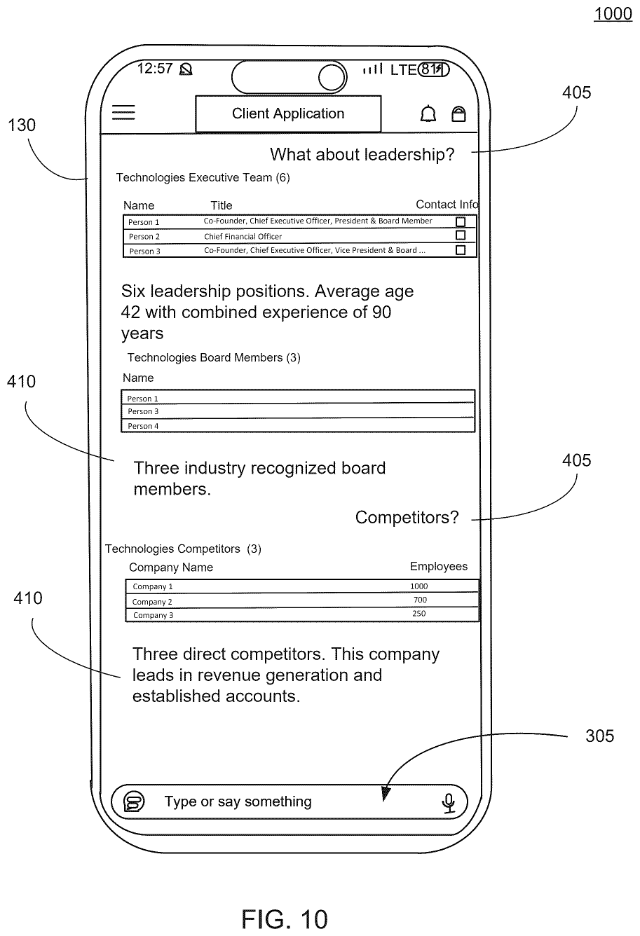

Referring to FIG. 10, a GUI 1000 is shown, according to an example embodiment. The GUI 1000 may be generated by the provider institution computing system 110 for display on the user device 130. In other embodiments, the GUI 1000 is generated by the client application 136. In some embodiments, the GUI 1000 may be displayed to a user during a session with the client application 136. The session with the client application 136 may refer to an engagement/interaction with the client application 136. That is, the session may begin when a user successfully accesses the client application 136 using their authentication information. The session may end when a user exits/logs out of/closes the client application 136.

More specifically, the GUI 900 depicts an interaction between the user of the user device 130 and the client application 136 regarding market conditions. That is, the in response to the query 405 asking about leadership status in the market, the response 410 may include information relating to a company's executive leadership. As shown in FIG. 10, the user may respond to the information by submitting a query 405 via the input field 305. For example, in response to the information relating to the company's executive leadership, the user may ask about competitors in the market. Based on the query 405, the client application 136 may present a response 410. In the example shown in FIG. 10, the response 410 may include information relating to market competitors. In some embodiments, the information presented via the GUI 1000 is retrieved from the third-party computing system 120.

Although FIGS. 3-10 depict various interactions between the user of the user device 130 and the client application 136, interactions between the user of the user device 130 and the client application 136 are not limited to those depicted in the figures. For instance, in an aspect, the client application 136 can receive a query of “Help me buy my first stock” via the unified interface. For example, the client application 136 can receive a query of “If I bought 100 shares of stock in Company X in [year] how much would I have now?” In response, the provider institution computing system 110 can provide textual data to the client application 136 including a value of 100 shares of the stock at the current market price. The client application 136 can then receive a further query from the user of “Any other stocks like this?” In response, the provider institution computing system 110 can provide text or media data to the client application 136 including an industry overview and a suggestion of ETFs and stocks that have similar trendlines, fundamentals, industries, or other aspects to the stock in the earlier query. In an aspect, the provider institution computing system 110 can provide fractional shares credit offered for stock, if user goes through learning modules that the client application 136 can present via the unified user interface. In an aspect, the provider institution computing system 110 can provide a trading simulation (e.g., paper trading) that the client application 136 can present via the unified user interface. In an aspect, the provider institution computing system 110 can purchase a fractional share in a given stock identified by the use or according to one or more trading preferences of a user, and can provide a suggestion for biweekly investments, that the client application 136 can present via the unified user interface. For example, the investment can be a periodically recurring investment (e.g., biweekly) of a given number of dollars. For example, the investment can be made (e.g., funds transferred) when a user is paid by an employer into an account of the provider institution or a third-party financial institution.

In an aspect, the client application 136 can receive a query of “Help me start my doughnut business” via the unified interface. For example, subsequent to the query in the chatbot interface, the client application 136 can present a reply including a request of “Do you have a business plan? Please upload it here.” in the chatbot application. Then, the user can upload a rough business plan (e.g., document). The client application 136 can present a reply that includes suggested next steps of services or products by the provider institution. In an aspect, the provider institution computing system 110 can generate an ABA loan referral/application using information of the user according to an authentication level as discussed herein (e.g., for a customer). In an aspect, the provider institution computing system 110 can schedule a video call with a provider institution representative. The client application 136 can present the video call via the unified interface. In an aspect, the provider institution computing system 110 can perform business checking setup. In an aspect, the provider institution computing system 110 can perform point-of-sale platform integration according to one or more options associated with preferences of the user. For example, the provider institution computing system 110 can obtain the preferences according to the authentication level of the user, and can obtain the preferences from the provider institution computing system 110 or a third-party financial institution according to the authentication level of the user at the client application 136. In an aspect, the provider institution computing system 110 can provide sales event support (e.g., for a pop-up doughnut sale), via the unified interface. For example, the support can include a report to provide day X sales as part of a pop-up event sales report). In an aspect, the provider institution computing system 110 can transmit a given report or data to accounting software for a given user, if the user authentication level allows transmission of the given report.

In an aspect, the client application 136 can receive a query of “Help me with my move” via the unified interface. In an aspect, the provider institution computing system 110 can perform an address change. For example, the client application 136 can receive image data for pictures of mail with a new address from a user, via the unified interface, and can provide the images or the new address to the provider institution computing system 110. In an aspect, the provider institution computing system 110 can cause the client application 136 to present a reply suggesting an option to update bill pay and third-party accounts addresses. For example, the provider institution computing system 110 can update the bill pay and third-party accounts addresses, in response to the client application 136 receiving a reply form the user of “yes” to the query with the option. In an aspect, the provider institution computing system 110 can perform utility setup automatically (e.g., Internet or electrical services). In an aspect, the provider institution computing system 110 can execute a renter insurance purchase through a partner institution. In an aspect, the provider institution computing system 110 can cause the client application 136 to offer an option to store images and serial information on big-ticket items for renter's insurance. For example, big-ticket items can include appliances, electronics, jewelry, or clothing, but are not limited thereto. In an aspect, the provider institution computing system 110 can identify a closest branch and ATM information to the new address, and cause the client application 136 to offer to save locations for the closest ATM or branch in a vehicle navigation or vehicle use profile.

In an aspect, the client application 136 can receive a query of “Help me renovate my kitchen” via the unified interface. For example, the client application 136 can receive, in the unified interface, at least one of a 3D model, a visualization, or an augmented reality (AR) scan, to start a chatbot interaction for exploring a renovation. For example, the client application 136 can present a cost estimator interaction based on the input received to start the interaction. For example, the client application 136 can receive input including context through third-party applications or media content (e.g., style board). In response, the provider institution computing system 110 can update a cost estimate based on guidance (e.g., parameters, preferences, metrics) determined from the context. For example, the style board can include photos of particular types of renovation items (e.g., flooring, window treatments, appliances, or any combination thereof). For example, the provider institution computing system 110 can identify costs of the detected renovation items and can update the cost estimate accordingly, for the client application 136 to present as a reply according to the unified interface. In an aspect, the provider institution computing system 110 can dynamically determine a current value estimate for a house of the user or the renovation, and can determine a potential value increase for the house upon completion of the renovation. In an aspect, the provider institution computing system 110 can determine an available range of credit and conditional approval for a home equity line or credit (“HELOC”) or other type of financing. For example, the provider institution computing system 110 can schedule video call for help with estimate and loan discussion, that the client application 136 can present in or launch from the unified interface. In an aspect, the provider institution computing system 110 can set up a renovation cost and spend tracking module to dynamically modify the above-noted estimates based on actual spend during the course of the renovation project or changes to the renovation plan (e.g., change of appliance or finishings).

In an aspect, the client application 136 can receive a query of “Help me establish an emergency fund” via the unified interface. For example, the provider institution computing system 110 can generate an initial assessment of salary, savings and spend for an authenticated user, with minimal input, due to access to financial information of the user according to an authentical level as discussed herein. In an aspect, the provider institution computing system 110 can set up savings goals based on custom suggestions in view of the financial information (e.g., monthly income, monthly spending, housing expenses, etc.) for the given authenticated user. In an aspect, the provider institution computing system 110 can perform automated savings routing per paycheck to a “rainy day lockbox” subcategory in an account balance or account summary of an authenticated user. In an aspect, the provider institution computing system 110 can provide interest optimization suggestions, to for example, suggest products or services than can reduce interest payments associated with an authenticated user. In an aspect, the provider institution computing system 110 can provide progress tracking and dynamic adjustment suggestions based on spend, that the client application 136 can present in the unified interface. In an aspect, the provider institution computing system 110 can determine life changes and milestones, and can suggest products and services to achieve one or more financial goals according to the life changes or milestones (e.g., reducing a monthly allocation amount to a financial goal upon detecting that a user has retired).

In an aspect, the client application 136 can receive a query of “Help me manage my rental properties” via the unified interface. In an aspect, the provider institution computing system 110 can help set aside X of tenant rent transfers for repairs, according to a determination of an amount that is a percentage of the rent collected from the property, the condition of the property, or any combination thereof. The client application 136 can generate text to request the above-noted information by the unified interface. For example, the client application 136 can present an inaction event alert (e.g., indicating that a tenant did not pay rent by date X). In an aspect, the provider institution computing system 110 can automatically track rental repair costs and maintenance costs over time, with respect to a given property or properties of the authenticated user, and the client application 136 can present text or chart summaries of these costs in response to queries by the user at the unified interface. For example, the client application 136 can receive a query of “how much did I pay last year for HOA fees?” In response, the provider institution computing system 110 can generate a reply including a figure for the amount paid in HOA fees for the property last year, and the client application 136 can present the reply including the figure at the unified interface. For example, the client application 136 can receive a query for a long-term investment analysis, with rate of return to date and expected return in the future to a given event. For example, an event can be a break-even event or can be a pay-off for a loan against the property.

It should be appreciated that this technical solution, including the client application 136 and the provider institution computing system 110, can provide a variety of chatbot experiences across a variety of subject matter scenarios. Thus, this technical solution is not limited to the example use cases and interfaces illustrated in FIGS. 3-10. For example, the client application 136 and the provider institution computing system 110 can provide one or more of the chatbot experiences discussed above, in addition to or in place of any chatbot experience discussed herein, but is not limited thereto.

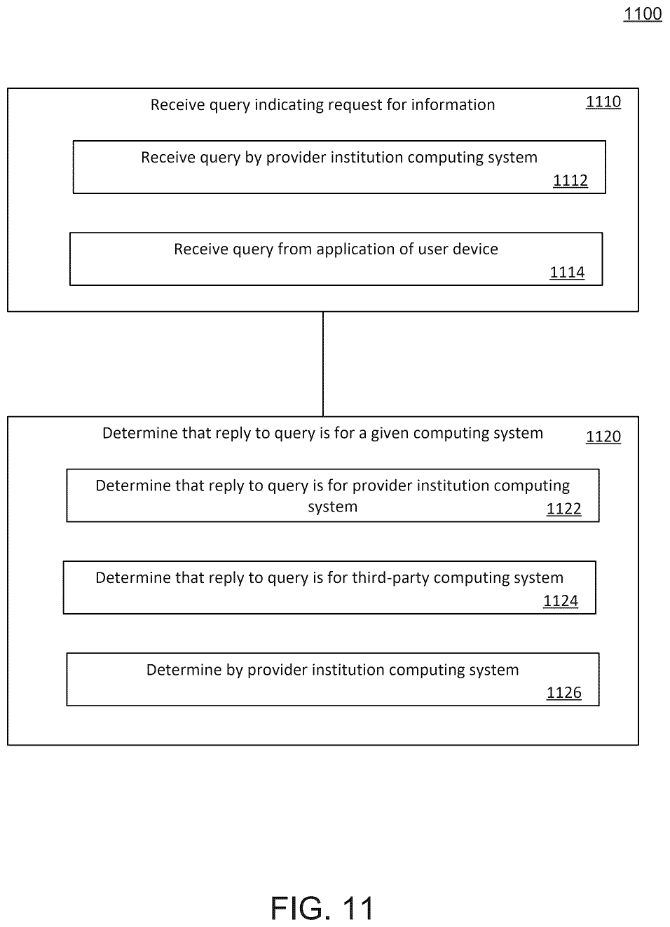

Referring now to FIG. 11, a flow diagram of a method 1100 for using a multimodal chatbot system with authentication levels for various institutions and users is shown, according to an example embodiment. Various operations of the method 1100 may be conducted by the system 100 and particularly parts thereof (e.g., the provider institution computing system 110, the third-party computing system 120, the user device 130). It should be understood that not all method steps/processes may be performed to “complete” the method. Certain steps/processes may be omitted in other embodiments, and still fall within the scope of the present disclosure.

At step 1110, a query indicating a request for information is received. In an aspect, the backend gateway 220 can obtain, by the provider institution computing system 110, the data from the provider institution computing system 110 via the first authentication layer. At step 1112, the query is received by the provider institution computing system 110. In an aspect, the one or more of the first AI circuits 260 and the second AI circuits 270 can obtain, by the provider institution computing system 110, the data from the third-party computing system 120 via an API configured according to the second authentication layer. At step 1114, the query is received from an application of the user device 130.

At step 1120, it is determined that a reply to the query is for a given computing system. In an aspect, the agent routing rules circuit 250 can determine, by the provider institution computing system 110, that the query is associated with a service of the provider institution computing system 110. The agent routing rules circuit 250 can authenticate, by the provider institution computing system 110, the user of the user device 130 using the first authentication layer in response to the determination that the query is associated with a service of the provider institution computing system 110. At step 1122, it is determined that a reply to the query is for the provider institution computing system 110. At step 1124, it is determined that a reply to the query is for the third-party computing system 120 (e.g., external to the provider institution computing system 110). At step 1126, the provider institution computing system 110 makes the determination.

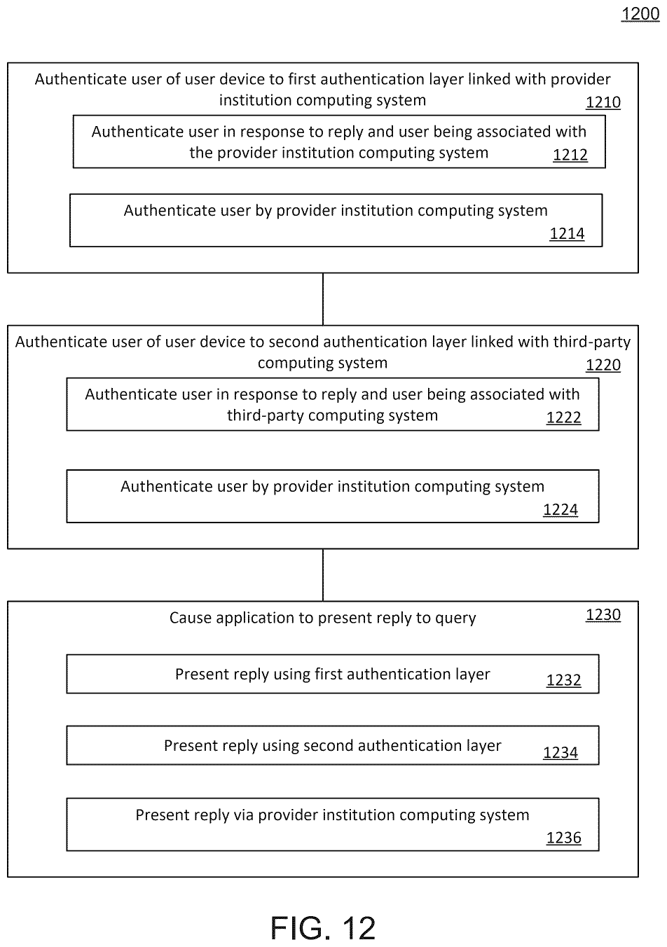

Referring now to FIG. 12, a method 1200 for using a multimodal chatbot system with authentication levels for various institutions and users is shown is shown, according to an example embodiment. Various operations of the method 1200 may be conducted by the system 100 and particularly parts thereof (e.g., the provider institution computing system 110, the third-party computing system 120, the user device 130). It should be understood that not all method steps/processes may be performed to “complete” the method. Certain steps/processes may be omitted in other embodiments, and still fall within the scope of the present disclosure.

At step 1210, a user of the user device 130 is authenticated to a first authentication layer linked with the provider institution computing system 110. In an aspect, the data of the provider institution computing system 110 is restricted by the first authentication layer. In an aspect, the one or more of the first AI circuits 260 and the second AI circuits 270 can authenticate, by the provider institution computing system 110, the user of the user device 130 to the first authentication layer, the second authentication layer, or a third authentication layer indicating that the user is not authenticated. At step 1212, the user is authenticated in response to the reply and the user being associated with the provider institution computing system 110. At step 1214, the user is authenticated by the provider institution computing system 110. In an aspect, can obtain, by the provider institution computing system, an identifier of the user. In an aspect, the query can include at least one of text, image, or video data. In an aspect, the reply can include at least one of text, multimedia content based on data of the provider institution computing system, or data of the external computing system. In an aspect, the reply can include at least one of an interactive object based on data of the provider institution computing system, or an interactive object based on data of the external computing system. In an aspect, one or more of the first AI circuits 260 and the second AI circuits 270 can obtain, by the provider institution computing system, the reply to the query from a large language model. In an aspect, the query is structured according to a natural language corresponding to the large language model. In an aspect, the reply is associated with execution of an action by the provider institution computing system, and the query is associated with the action by the provider institution computing system. In an aspect, the reply is associated with execution of an action by the external computing system, and the query is associated with the action by the external computing system.

At step 1220, the user of the user device 130 is authenticated to a second authentication layer linked with the third-party computing system 120. In an aspect, the data of the third-party computing system 120 is restricted by the second authentication layer. At step 1222, the user is authenticated in response to the reply and the user being associated with the third-party computing system 120. At step 1224, the user is authenticated by the provider institution computing system 110.

At step 1230, the application is caused to present the reply to the query. In an aspect, the backend gateway 220 can cause, by the provider institution computing system 110, the application to present the reply according to data of the provider institution computing system 110, in response to the reply and the user being associated with the provider institution computing system 110. At step 1232, the reply is presented according to the first authentication layer. At step 1234, the reply is presented according to the second authentication layer. At step 1236, the reply is presented via the provider institution computing system 110. In an aspect, the response aggregation and formatting circuit can cause, by the provider institution computing system 110, the application to present the reply to include the data from the provider institution computing system 110, in a chatbot format responsive to the query. In an aspect, the response aggregation and formatting circuit can cause, by the provider institution computing system 110, the application to present the reply according to data of the third-party computing system 120, in response to the reply and the user being associated with the third-party computing system 120.

In an aspect, the agent routing rules circuit 250 can determine, by the provider institution computing system, that the query is associated with a service of the external computing system. The first AI circuits 260 and the second AI circuits 270 can authenticate, by the provider institution computing system, the user of the client device to the second authentication layer in response to the determination that the query is associated with a service of the provider institution computing system.

In an aspect, the provider institution computing system is controlled by a first financial institution, and the external computing system is controlled by a second financial institution independent of the first financial institution. In an aspect, the second financial institution is at least one of a bank, a digital payment processor, a tax services provider, an accounting service, an investment manager, a brokerage, or a credit card payment processor. In an aspect, the provider institution computing system is controlled by a financial institution, and the external computing system is controlled by a service provider independent of the first financial institution. In an aspect, the service provider is at least one of a travel booking platform, a restaurant booking platform, a tax preparation platform, or a chat platform. In an aspect, the application corresponds to a chatbot application, and the query, the reply, and the reply are each presented according to a chat format of the chatbot application.

In an aspect, by the provider institution computing system, the application is caused to present the reply according to data of the provider institution computing system, in response to the reply and the user being associated with the provider institution computing system. In an aspect, by the provider institution computing system, the data from the provider institution computing system is obtained via the first authentication layer. In an aspect, the data of the provider institution computing system is restricted by the first authentication layer. In an aspect, by the provider institution computing system, the application is caused to present the reply can include the data from the provider institution computing system, in a chatbot format responsive to the query. In an aspect, by the provider institution computing system, the application is caused to present the reply according to data of the external computing system, in response to the reply and the user being associated with the external computing system. In an aspect, by the provider institution computing system, the data from the external computing system is obtained via an application programming interface configured according to the second authentication layer. In an aspect, the data of the external computing system is restricted by the second authentication layer.

In an aspect, by the provider institution computing system, the application is caused to present the reply can include the data from the provider institution computing system, in a chatbot format responsive to the query. In an aspect, a non-transitory computer readable medium can include one or more instructions executable by a processor. The processor can cause the application to present the reply according to data of the provider institution computing system, in response to the reply and the user being associated with the provider institution computing system. In an aspect, the processor can obtain the data from the provider institution computing system via the first authentication layer. In an aspect, the data of the provider institution computing system is restricted by the first authentication layer.

In an aspect, the processor can cause the application to present the reply can include the data from the provider institution computing system, in a chatbot format responsive to the query. In an aspect, the processor can cause the application to present the reply according to data of the external computing system, in response to the reply and the user being associated with the external computing system. In an aspect, the processor can obtain the data from the external computing system via an application programming interface configured according to the second authentication layer. In an aspect, the data of the external computing system is restricted by the second authentication layer. In an aspect, the processor can cause the application to present the reply can include the data from the provider institution computing system, in a chatbot format responsive to the query.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A provider computing system, comprising:
at least one processing circuit having at least one processor coupled to at least one memory, the at least one memory storing instructions thereon that, when executed by the at least one processor, cause the at least one processing circuit to perform operations comprising:
receiving, from an application of a client device, a query indicating a request for information;
determining that a reply to the query is associated with the provider computing system or an external computing system external to the provider computing system;
authenticating a user of the client device to a first authentication layer linked with the provider computing system in response to the reply and the user being associated with the provider computing system;
authenticating the user of the client device to a second authentication layer linked with the external computing system, in response to the reply and the user being associated with the external computing system; and
causing the application to present the reply to the query according to the first authentication layer or the second authentication layer.

2. The provider computing system of claim 1, wherein the instructions, when executed by the at least one processor, further cause the at least one processing circuit to perform operations comprising:
causing the application to present the reply according to data of the provider computing system, in response to the reply and the user being associated with the provider computing system.

3. The provider computing system of claim 2, wherein the instructions, when executed by the at least one processor, further cause the at least one processing circuit to perform operations comprising:
obtaining the data from the provider computing system via the first authentication layer,
wherein the data of the provider computing system is restricted by the first authentication layer.

4. The provider computing system of claim 2, wherein the instructions, when executed by the at least one processor, further cause the at least one processing circuit to perform operations comprising:
causing the application to present the reply including the data from the provider computing system, in a chatbot format responsive to the query.

5. The provider computing system of claim 1, wherein the instructions, when executed by the at least one processor, further cause the at least one processing circuit to perform operations comprising:
causing the application to present the reply according to data of the external computing system, in response to the reply and the user being associated with the external computing system.

6. The provider computing system of claim 5, wherein the instructions, when executed by the at least one processor, further cause the at least one processing circuit to perform operations comprising:
obtaining the data from the external computing system via an application programming interface configured according to the second authentication layer,
wherein the data of the external computing system is restricted by the second authentication layer.

7. The provider computing system of claim 5, wherein the instructions, when executed by the at least one processor, further cause the at least one processing circuit to perform operations comprising:
causing the application to present the reply including the data from the provider computing system, in a chatbot format responsive to the query.

8. The provider computing system of claim 1, wherein the instructions, when executed by the at least one processor, further cause the at least one processing circuit to perform operations comprising:
authenticating the user of the client device to the first authentication layer, the second authentication layer, or a third authentication layer indicating that the user is not authenticated.

9. The provider computing system of claim 1, wherein the instructions, when executed by the at least one processor, further cause the at least one processing circuit to perform operations comprising:
determining that the query is associated with a service of the provider computing system; and
authenticating the user of the client device to the first authentication layer in response to the determination that the query is associated with a service of the provider computing system.

10. The provider computing system of claim 1, wherein the instructions, when executed by the at least one processor, further cause the at least one processing circuit to perform operations comprising:
determining that the query is associated with a service of the external computing system; and
authenticating the user of the client device to the second authentication layer in response to the determination that the query is associated with a service of the provider computing system.

11. A method, comprising:
receiving, by a provider computing system from an application of a client device, a query indicating a request for information;
determining, by the provider computing system, that a reply to the query is associated with the provider computing system or an external computing system external to the provider computing system;
authenticating, by the provider computing system, a user of the client device to a first authentication layer linked with the provider computing system, in response to the reply and the user being associated with the provider computing system;
authenticating, by the provider computing system, the user of the client device to a second authentication layer linked with the external computing system, in response to the reply and the user being associated with the external computing system; and
causing, by the provider computing system, the application to present the reply to the query according to the first authentication layer or the second authentication layer.

12. The method of claim 11, wherein the method further comprises:
causing, by the provider computing system, the application to present the reply according to data of the provider computing system, in response to the reply and the user being associated with the provider computing system.

13. The method of claim 12, wherein the method further comprises:
obtaining, by the provider computing system, the data from the provider computing system via the first authentication layer, wherein the data of the provider computing system is restricted by the first authentication layer.

14. The method of claim 12, wherein the method further comprises:
causing, by the provider computing system, the application to present the reply including the data from the provider computing system, in a chatbot format responsive to the query.

15. The method of claim 11, wherein the method further comprises:
causing, by the provider computing system, the application to present the reply according to data of the external computing system, in response to the reply and the user being associated with the external computing system.

16. The method of claim 15, wherein the method further comprises:
obtaining, by the provider computing system, the data from the external computing system via an application programming interface configured according to the second authentication layer, wherein the data of the external computing system is restricted by the second authentication layer.

17. The method of claim 15, wherein the method further comprises:
causing, by the provider computing system, the application to present the reply including the data from the provider computing system, in a chatbot format responsive to the query.

18. A non-transitory computer readable medium including one or more instructions stored thereon that, when executed by one or more processors, cause the one or more processors to perform operations comprising:
receiving, from an application of a client device, a query indicating a request for information;
determining that a reply to the query is associated with a provider computing system or an external computing system external to the provider computing system;
authenticating a user of the client device to a first authentication layer linked with the provider computing system in response to the reply and the user being associated with the provider computing system;
authenticating the user of the client device to a second authentication layer linked with the external computing system, in response to the reply and the user being associated with the external computing system; and
causing the application to present the reply to the query according to the first authentication layer or the second authentication layer.

19. The non-transitory computer readable medium of claim 18, wherein the one or more instructions, when executed by the one or more processors, cause the one or more processors to perform additional operations comprising:
obtaining data from the provider computing system via the first authentication layer in response to the reply and the user being associated with the provider computing system; and
causing the application to present the reply according to the data of the provider computing system, wherein the application presents the reply in a chatbot format responsive to the query.

20. The non-transitory computer readable medium of claim 18, wherein the one or more instructions, when executed by the one or more processors, cause the one or more processors to perform additional operations comprising:
obtaining, in response to the reply and the user being associated with the external computing system, data from the external computing system via an application programming interface configured according to the second authentication layer; and
causing the application to present the reply according to the data of the external computing system, wherein the application presents the reply in a chatbot format responsive to the query.
